(19) United States
(12) Patent Application Publication
(10) Pub. No.: US 2010/0037090 A1
(43) Pub. Date: Feb. 11, 2010

(54) STORAGE SYSTEM, CONTROL METHOD FOR STORAGE SYSTEM, AND STORAGE DEVICE

(75) Inventor: Seiji Inamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/489,155

(22) Filed: Jun. 22, 2009

(30) Foreign Application Priority Data
Aug. 6, 2008 (JP) 2008-203612

(51) Int. Cl. G06F 11/07; G06F 11/00; G06F 15/177

(52) U.S. Cl. 714/5; 714/49; 713/2; 714/E11.024

(57) ABSTRACT

In a control method for a storage system including a plurality of storage devices connected via a network, when starting operation, a first storage device on the network determines whether data of a control program for controlling the first storage device is broken. When the data of the control program is broken, the first storage device transmits a signal indicating that the data of the control program is broken to the network. Upon receipt of the signal, a second storage device on the network determines whether it stores the same control program as that stored in the first storage device. When storing the same control program, the second storage device transmits the control program to the first storage device. The first storage device rewrites the broken control program with the control program received from the second storage device.

### CROSS-REFERENCE TO RELATED APPLICATION(S)

This application is based upon and claims the benefit of priority of the prior Japanese Patent Application No. 2008-203612, filed on Aug. 6, 2008, the entire contents of which are incorporated herein by reference.

### FIELD

The embodiment discussed herein is directed to a storage system including a plurality of storage devices connected via a network.

### BACKGROUND

Firmware codes that control a magnetic disk unit, i.e., one of storage devices, are stored in a flash memory and a magnetic disk medium. The firmware codes are loaded into a read only memory (RAM) from the flash memory when the power is turned on, and a micro processing unit (MPU) reads and executes the program codes on the RAM. Because of its expensive price, a flash memory with a smaller memory capacity is generally used. Accordingly, the flash memory stores only minimum necessary firmware codes used until the code recorded on a magnetic disk is read by rotating a spindle motor. Firmware codes read from the magnetic disk are used to control the magnetic disk unit.

When a problem due to a firmware operation occurs in a magnetic disk unit, the firmware codes may need to be updated to handle the problem occurred in the magnetic disk unite. When the firmware codes are updated, a host transmits new firmware codes to the magnetic disk unit. The firmware codes stored in the flash memory and the magnetic disk unit are then rewritten. This updating operation is referred to as firmware download.

During the firmware download, if the download is interrupted due to power supply disconnection or a problem in the host, only part of the firmware codes stored in the flash memory and the like is rewritten. Because rewriting of the firmware codes stored in the flash memory is incomplete, the magnetic disk unit cannot be activated properly. If the magnetic disk unit cannot be activated properly, firmware codes cannot be received from the host. Accordingly, the recovery operation of the magnetic disk unit has to be made manually, not automatically, thereby taking a long time until recovery. In a system such as a storage system in which high availability is important, there is a need for reduction of time required for system maintenance.

Japanese Laid-open Patent Publication No. 2001-216166 and Japanese Laid-open Patent Publication No. 2004-054421 disclose conventional technologies related to the foregoing.

### SUMMARY

According to an aspect of an embodiment, there is provided a control method for a storage system including a plurality of storage devices connected via a network. The control method includes: executing a boot program for booting each of the storage devices to detect whether data constituting a control program for controlling each of the storage devices is broken; detecting, when the data constituting the control program is broken, a storage device constituting the network; transmitting a signal indicating that the data constituting the control program is broken to the storage device detected at the detecting; comparing, upon receipt of the signal, first identification information that identifies a storage device having transmitted the signal with second identification information that identifies a storage device having received the signal to determine whether the storage device having transmitted the signal and the storage device having received the signal are of the same type; transmitting, when the storage devices are of the same type, a control program stored in the storage device having received the signal to the storage device having transmitted the signal; and storing the control program in the storage device having transmitted the signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is an example diagram of a system of a magnetic disk unit according to an embodiment of the invention;

FIG. 2 is an example diagram of the magnetic disk unit according to the embodiment;

FIG. 3 is an example diagram for explaining an initializing process of a network;

FIG. 4 is an example diagram for explaining a process after completion of the initializing process of the network;

FIG. 5 is an example diagram for explaining a write buffer process;

FIG. 6 is another example diagram for explaining the write buffer process;

FIG. 7 is an example flowchart of a firmware updating process; and

FIG. 8 is an example flowchart of a firmware transmitting process.

### DESCRIPTION OF EMBODIMENT(S)

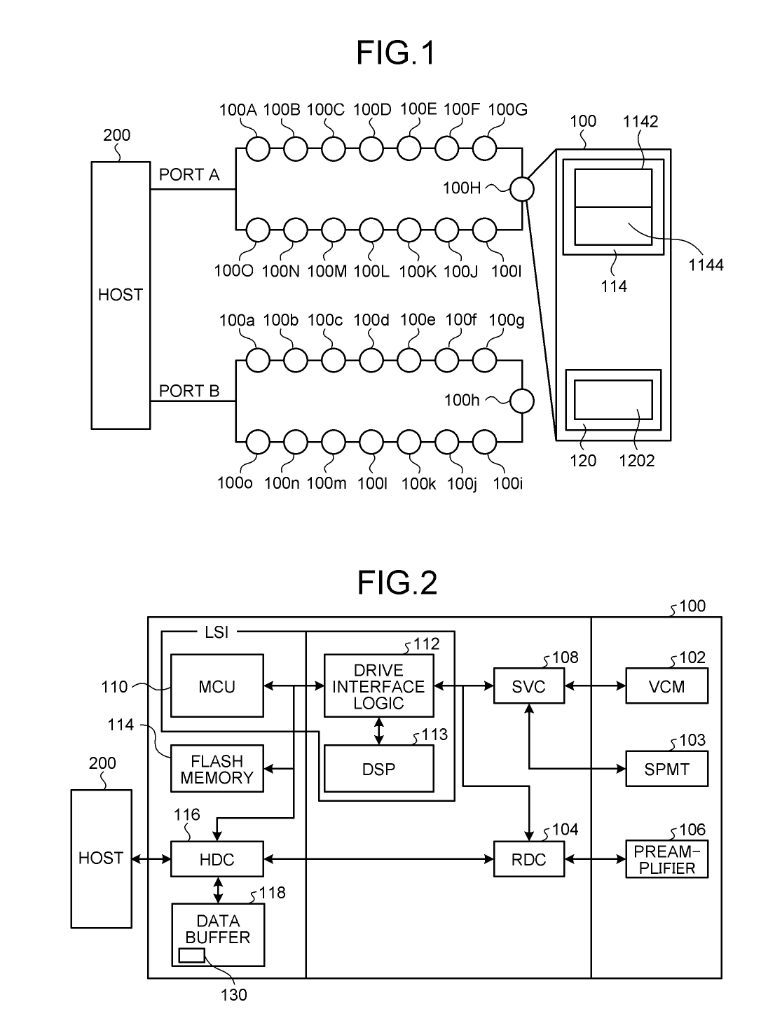

Exemplary embodiments of the invention will be explained with reference to the accompanying drawings. FIG. 1 depicts a storage system including a magnetic disk unit according to an embodiment of the invention. As illustrated in FIG. 1, the storage system includes a plurality of magnetic disk units 100A to 1000, and 100a to 100o. An alphabetical letter is assigned to each of the magnetic disk units 100 to distinguish them. As a network technology for connecting the respective magnetic disk units 100, a network using an optical fiber is used. There is a fiber channel as an interface standard on an optical fiber cable. In the system according to the embodiment, each of the magnetic disk units 100 has at least one magnetic disk unit of the same type as the own unit in the network. A host 200 transmits a command to each of the magnetic disk units 100 through a port A or a port B. The magnetic disk units 100A to 1000 are connected to the port A, and the magnetic disk units 100a to 100o are connected to the port B.

A flash memory 114 stores an activation code 1142 and a first firmware code 1144. A second firmware code 1202 is stored in a magnetic disk 120. The first firmware code 1144 is used for initializing the magnetic disk unit 100. The first firmware code 1144 is also used for allowing a digital signal processor (DSP) 113 to perform arithmetic processing. On the other hand, the second firmware code 1202 is used for controlling the magnetic disk unit 100, and for receiving a command from the host 200 and performing reading and writing of data.

The activation code 1142 is a control code for activating the magnetic disk unit 100. The activation code 1142 is implemented with a function for participating in the network to detect the magnetic disk unit of the same type as the magnetic disk unit having the activation code 1142 when the first firmware code 1144 or the second firmware code 1202 is broken. The activation code 1142 is also implemented with a function for receiving a control firmware code from the magnetic disk unit of the same type to store it in a data buffer 118, and shifting the control to the firmware code stored in the data buffer 118 after reactivation of the magnetic disk unit. After factory shipment, rewriting is prohibited to an area of the flash memory 114 in which the activation code 1142 is stored. By making the area unrewritable, even if power supply disconnection occurs during the download of the firmware, the activation code 1142 is not broken. The activation code 1142 also has a function for examining whether the first firmware code 1144 stored in a rewritable area of the flash memory 114 or the second firmware code 1202 stored in the magnetic disk 120 is broken when the system is turned on. The area of the flash memory 114 in which the first firmware code 1144 is stored is made rewritable. By making the area rewritable, when there is a bug in the DSP 113, the first firmware code 1144 is updated to handle the bug.

After activating the firmware code stored in the data buffer 118, the firmware code is rerecorded in the flash memory 114 and the magnetic disk 120 according to a process of the normal write buffer.

In a complete operation state in which the firmware code is not broken, upon receipt of login from the magnetic disk unit including a broken control code, it is recognized that the magnetic disk unit is of the same type as the own unit based on device information received together with a login command. After responding to the magnetic disk unit ACK (acknowledge), the magnetic disk unit transmits Write Buffer and the firmware code. ACK and Write Buffer are both signals.

FIG. 2 depicts the magnetic disk unit 100 according to the embodiment. In FIG. 2, a magnetic head (not illustrated) is attached to an end of an arm (not illustrated) provided in a voice coil motor (VCM) 102. The magnetic head is a combined head in which a read element and a write element are separated from each other.

A read channel circuit (RDC) 104 shapes a read signal read by the magnetic head from a preamplifier 106, generates a synchronous clock and a gate signal, and outputs the read signal.

A servo combo circuit (SVC) 108 receives a drive command value from a micro controller unit (MCU) 110, and outputs a driving current corresponding to the drive control value to drive the VCM 102. A magnetic disk (not illustrated) is mounted on a rotation shaft of a spindle motor (SPMT) 103. Rotation of the magnetic disk is realized by the SPMT 103.

The MCU 110 includes a micro processor (MPU) and a servo controller, demodulates position information obtained from a read signal from the read channel circuit 104 obtained via a drive interface logic (DIL) 112 to detect a current position, and calculates a VCM drive command value according to a difference between the detected current position and a target position. That is, the MCU 110 performs servo control including seek and following operations. The MCU 110 also performs analysis of the command, status monitoring of the unit, and control of respective parts of the unit. The DSP 113 calculates a code for controlling the magnetic disk unit 100 to control the magnetic disk unit 100.

The flash memory 114 stores the activation code 1142 and the first firmware code 1144. The activation code 1142 is run in the RAM provided in the MCU 110 and executed. When the activation code 1142 is executed, the first firmware code 1144 is then run in the RAM provided in the MCU 110 and executed. By executing the first firmware code 1144, the SPMT 103 rotates so that the second firmware code stored in the magnetic disk 120 is run in the RAM and executed. By executing the second firmware code, reception of command from the host 200 and data reading and writing are performed.

A hard disk controller (HDC) 116 performs communication with the host 200, receives read data from the read channel circuit 104 according to the gate signal and clock from the read channel circuit 104, stores the read data in the data buffer 118, and transfers the read data to the host 200. Further, the HDC 116 outputs write data from the host to the read channel circuit 104 according to the gate signal and clock from the read channel circuit 104.

In the example of FIG. 2, the HDC 116 transfers data to/from the host 200. The SVC 108 outputs the driving current of the VCM 102 for seek and following operations of the magnetic head, and the MCU 110 performs control of respective parts including seek and following according to the command received by the HDC 116.

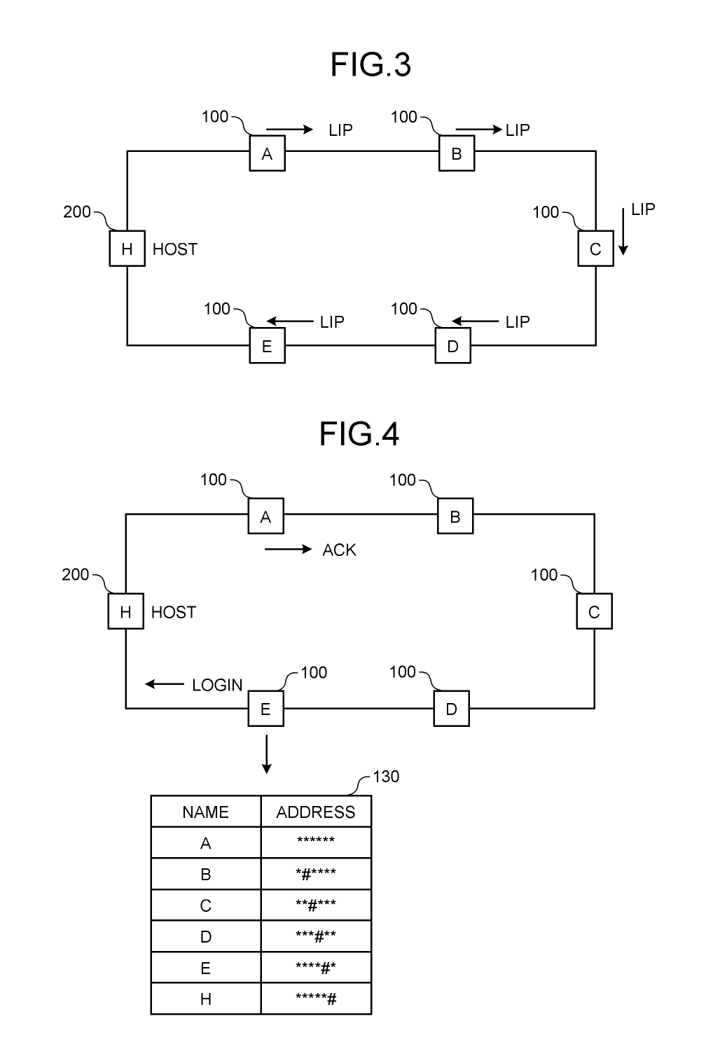

FIG. 3 depicts an initializing process of the network. In the embodiment, a case that activation cannot be performed because the firmware code of the magnetic disk unit 100E is broken is explained.

Because the activation code 1142 of the magnetic disk unit 100E is executed, the magnetic disk unit 100E starts to connect to the network. The network has a loop configuration, and a plurality of magnetic disk units is connected in the loop. After power-on of the system, the loop configuration is reset. Therefore, each magnetic disk unit on the loop transmits Loop Initialize Primitive (LIP) to shift to a loop initializing procedure, and obtains an address of the magnetic disk unit constituting the network upon completion of the loop initializing procedure. The LIP is a signal informing the respective magnetic disk units constituting the network of a shift to the loop initializing procedure.

FIG. 4 depicts a process after completion of the loop initializing procedure of the network. When the initializing process of the network is complete, the magnetic disk unit 100E in which the firmware code is broken can confirm presence of the magnetic disk units participating in the network according to an arbitrated loop physical address map (ALPA MAP) 130. In the ALPA MAP 130, addresses in the network of the magnetic disk units are listed. For example, as illustrated in FIG. 4, in the ALPA MAP 130, names and addresses of the magnetic disk units on the network are associated with each other. Respective magnetic disk units 100 refer to the ALPA MAP 130 to detect a magnetic disk unit of the same type from the magnetic disk units constituting the network, and obtain the firmware from the detected magnetic disk unit. The ALPA MAP 130 is provided in the data buffer 118.

The magnetic disk unit 100E refers to the ALPA MAP 130 to transmit a login command, for example, to an arbitrary magnetic disk unit 100A to attempt login. The login can be attempted sequentially with respect to from the magnetic disk unit 100A described at the top of the ALPA MAP 130, magnetic disk unit 100B, and magnetic disk unit 100C. The magnetic disk unit 100E sets a bit indicating that it is a login from the magnetic disk unit in the login command. The magnetic disk unit 100E then transmits the login command including the bit. Upon receipt of the login command including the bit, the magnetic disk unit 100A recognizes that a login source is not the host 200 but the magnetic disk unit. The magnetic disk unit 100A then transmits ACK to the magnetic disk unit 100E as the login source.

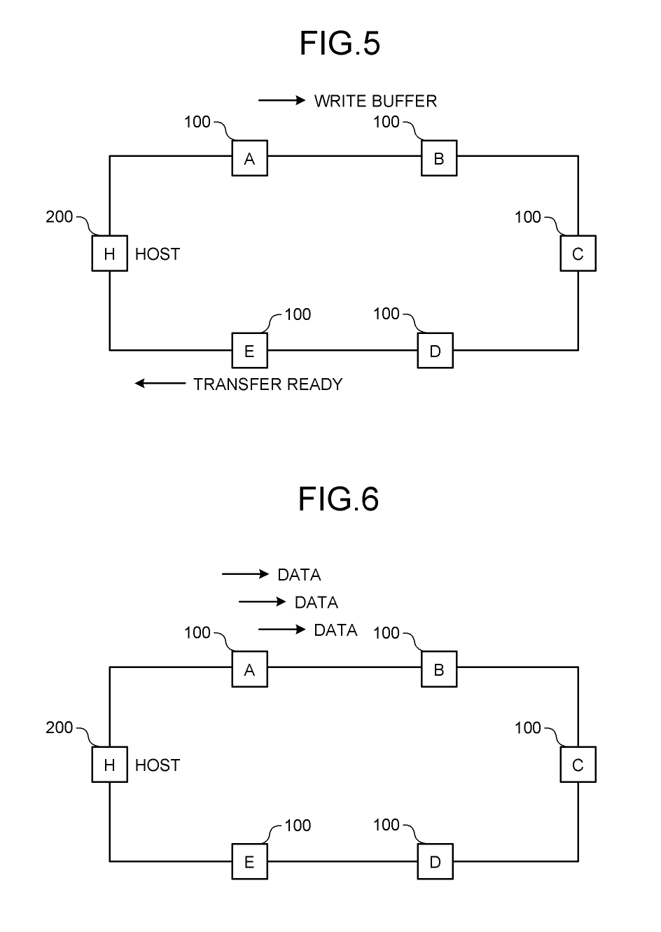

FIGS. 5 and 6 depict a write buffer process. As illustrated in FIG. 5, the magnetic disk unit 100A recognizes that the magnetic disk unit 100E as the login source requests firmware data, and transmits Write Buffer to the magnetic disk unit 100E. Upon receipt of Write Buffer, the magnetic disk unit 100E transmits Transfer Ready to the magnetic disk unit 100A, to request a required transfer length. Transfer Ready is a signal for requesting a required transfer length.

As illustrated in FIG. 6, the magnetic disk unit 100A starts to transfer the firmware data to the magnetic disk unit 100E. After completion of transfer of the firmware data, the magnetic disk unit 100E having received the data starts reactivation by the received firmware, to resume writing of firmware to the flash memory 114 and the magnetic disk 120.

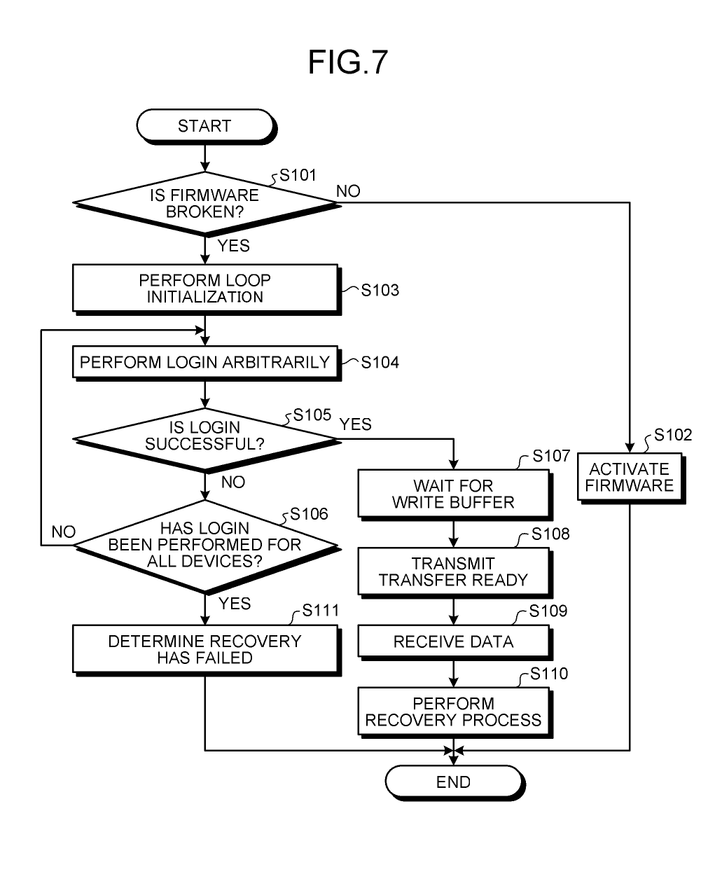

FIG. 7 is a flowchart of a firmware updating process in the magnetic disk unit 100E to be recovered.

At Step S101, the MCU 110 runs the activation code 1142 in the RAM provided in the MCU 110, to execute the activation code 1142. By running the activation code 1142 in the RAM, the function provided to the activation code is realized. The MCU 110 can determine whether the first firmware code 1144 stored in the flash memory 114 and the second firmware code 1202 stored in the magnetic disk 120 are broken. The MCU 110 determines whether the firmware code is broken. Specifically, the MCU 110 compares an error detection code added to the firmware code with an error detection code generated from the firmware code to determine whether these codes match. As a generation algorithm of the error detection code, for example, an arbitrary algorithm such as cyclic redundancy check (CRC) can be used. As a result of comparison of the error detection codes, when it is determined that the firmware code is not broken, the process proceeds to Step S102.

At Step S102, the MCU 110 runs the first firmware code 1144 in the RAM provided in the MCU 110, to thereby activate the first firmware code 1144 stored in the flash memory 114. The process is then finished.

Meanwhile, at Step S101, as a result of comparison of the error detection codes, when it is determined that the firmware code is broken, the process proceeds to Step S103.

At Step S103, an initializing process of the network is performed. Specifically, the MCU 110 transmits the LIP, to detect the magnetic disk units constituting the network. The MCU 110 also writes the addresses of the magnetic disk units constituting the network to the ALPA MAP 130. The process then proceeds to Step S104.

At Step S104, the MCU 110 refers to the ALPA MAP 130 in which the addresses of the magnetic disk units constituting the network are written at Step S103 to login to an arbitrary magnetic disk unit constituting the network. The login is performed by transmitting a login command in which a bit indicating that it is a login from a magnetic disk unit is set to the arbitrary magnetic disk unit. The process then proceeds to Step S105.

At Step S105, the MCU 110 determines whether the login to the arbitrary magnetic disk unit is successful. When the login is successful, ACK indicating that the login is successful is transmitted from the magnetic disk unit at a login destination to the magnetic disk unit at a login source. The MCU 110 determines whether the ACK has been received to thereby determine whether the login is successful. When the login has failed, the process proceeds to Step S106.

At Step S105, the MCU 110 refers to the ALPA MAP 130 to determine whether there is a magnetic disk unit to which login has not been performed. If there is no magnetic disk unit to which login has not been performed, the process proceeds to Step S111.

At Step S111, the MCU 110 determines that recovery has failed, and the process is finished.

Meanwhile, at Step S105, if there is a magnetic disk unit that has not performed login, the process returns to Step S104 to perform login with respect to the new magnetic disk unit.

At Step S105, if the login is successful, the process proceeds to Step S107.

At Step S107, the MCU 110 receives Write Buffer from the magnetic disk unit at the login destination. The process proceeds to Step S108.

At Step S108, the MCU 110 transmits Transfer Ready to the magnetic disk unit at the login destination, to request the required data transfer length. The process proceeds to Step S109.

At Step S109, the MCU 110 receives firmware data from the magnetic disk unit at the login destination. The MCU 110 stores the received firmware in the data buffer 118. The process proceeds to Step S110.

At Step S110, the MCU 110 performs a recovery process. Specifically, the MCU 110 reactivates the device by the activation code 1142, to shift control to the firmware stored in the data buffer 118. After the device is activated by the firmware stored in the data buffer 118, the MCU 110 starts writing of the firmware to the flash memory 114 and the magnetic disk 120. The process is then finished.

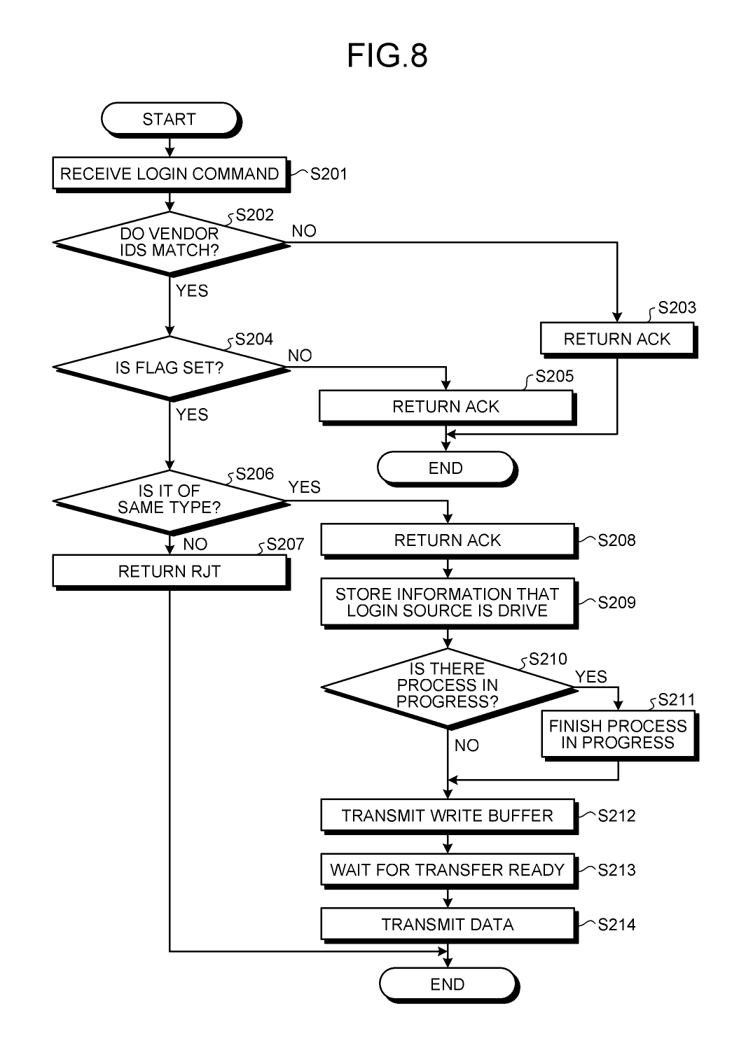

FIG. 8 is a flowchart of a firmware transmitting process in the magnetic disk unit 100A.

At Step S201, the magnetic disk unit 100 receives a login command from another magnetic disk unit 100 on the network. The process proceeds to Step S202.

At Step S202, the magnetic disk unit 100 compares Vender ID (vender identification data (VID)) included in the received login command with the Vender ID of the magnetic disk unit 100 to determine whether these Vender IDs match. When the Vender ID included in the received login command does not match the Vender ID of the magnetic disk unit 100, the magnetic disk unit 100A determines that a login subject is the host 200 manufactured by another company, and the process proceeds to Step S203.

At Step S203, the magnetic disk unit 100 transmits ACK to the host 200 to finish the process.

Meanwhile, when the Vender ID included in the received login command matches the Vender ID of the magnetic disk unit 100, the process proceeds to Step S204.

At Step S204, the magnetic disk unit 100 determines whether a bit indicating that it is a login from a magnetic disk unit is included in the received login command. When the bit is not included in the login command, the process proceeds to Step S205.

At Step S205, because the bit indicating that it is a login from a magnetic disk unit is not included in the received login command, the magnetic disk unit 100 can determine that a transmission source of the login command is the host 200. The magnetic disk unit 100 transmits ACK to the host 200 to finish the process.

Meanwhile, at Step S204, when the magnetic disk unit 100 determines that the bit indicating that it is a login from a magnetic disk unit is included in the received login command, the process proceeds to Step S206.

At Step S206, because the bit indicating that it is a login from a magnetic disk unit is included in the received login command, the magnetic disk unit 100 can determine that the transmission source of the login command is a magnetic disk unit. The magnetic disk unit 100 obtains information relating to the type of the magnetic disk unit at the transmission source of the login command from the received login command, to determine whether the type of the magnetic disk unit at the transmission source of the login command is the same as the own type. When the type of the magnetic disk unit at the transmission source of the login command is not of the same type, the process proceeds to Step S207.

At Step S207, because the type of the magnetic disk unit at the transmission source of the login command is not the same as the own type, the magnetic disk unit 100 transmits RJT (reject) to the magnetic disk unit 100 at the transmission source of the login command. By transmitting the RJT to the magnetic disk unit 100 at the transmission source of the login command, it is possible to inform the magnetic disk unit 100 that the update of the firmware cannot be performed. The process is then finished.

Meanwhile, at Step S206, when the magnetic disk unit 100 determines that the type of the magnetic disk unit at the transmission source of the login command is the same as the own type, the process proceeds to Step S208.

At Step S208, the magnetic disk unit 100 transmits ACK to the magnetic disk unit at the transmission source of the login command. The process proceeds to Step S209.

At Step S209, the magnetic disk unit 100 stores information that the login source is a magnetic disk unit. The process proceeds to Step S210.

At Step S210, the magnetic disk unit 100 determines whether there is a process in progress. When there is a process in progress, it proceeds to Step S211.

At Step S211, the magnetic disk unit 100 finishes the process in progress to transmit the firmware code to the magnetic disk unit at the login source. The process proceeds to Step S212.

Meanwhile, at Step S210, when the magnetic disk unit 100 determines that there is no process in progress, the process proceeds to Step S212.

At Step S212, because the magnetic disk unit 100 recognizes that the magnetic disk unit at the transmission source of the login command requests the firmware code, the magnetic disk unit 100 transmits Write Buffer to the magnetic disk unit at the transmission source of the login command. The process proceeds to Step S213.

At Step S213, the magnetic disk unit 100 receives Transfer Ready from the magnetic disk unit at the transmission source of the login command. The Process proceeds to Step S214.

At Step S214, the magnetic disk unit 100 transmits the firmware code to the magnetic disk unit at the transmission source of the login command. The process is then finished. The magnetic disk unit at a transmission destination of the firmware code reactivates the device by the received firmware, and starts writing of the firmware to the flash memory 114 and the magnetic disk 120.

According to the embodiment, even if power supply disconnection occurs during the download of the firmware and the firmware code in the flash memory is broken, the firmware code can be recovered in a short period of time. Thus, the user does not need to hesitate to perform firmware download, and can operate the disk unit according to the latest control firmware at all times. Further, by using the latest firmware in which measures against known problems have been taken, the reliability of the entire storage system can be improved.

Descriptions are given above of a specific embodiment of the invention to facilitate the understanding thereof, but other embodiments are also possible. In addition, the embodiment is susceptible to modifications and variations without departing from the spirit and scope thereof. For example, while firmware is described above as being stored in both the magnetic disk 120 and the flash memory 114, it may be stored in either one of the magnetic disk 120 and the flash memory 114.

As set forth hereinabove, according to the embodiment, when there is an abnormality in a firmware code, correction can be made using a firmware code sent from another magnetic disk unit connected via a network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A control method for a storage system including a plurality of storage devices connected via a network, the control method comprising:
executing a boot program for booting each of the storage devices to detect whether data constituting a control program for controlling each of the storage devices is broken;
detecting, when the data constituting the control program is broken, a storage device constituting the network;
transmitting a signal indicating that the data constituting the control program is broken to the storage device detected at the detecting;
comparing, upon receipt of the signal, first identification information that identifies a storage device having transmitted the signal with second identification information that identifies a storage device having received the signal to determine whether the storage device having transmitted the signal and the storage device having received the signal are of same type;
transmitting, when the storage devices are of same type, a control program stored in the storage device having received the signal to the storage device having transmitted the signal; and
storing the control program in the storage device having transmitted the signal.

2. The control method according to claim 1, wherein the boot program is stored in an unrewritable area of a storage device.

3. The control method according to claim 1, wherein the storing includes the storage device having transmitted the signal storing the control program upon receipt of the control program stored in the storage device having received the signal.

4. A storage system comprising:
a network via which information is transmitted;
a first storage device including a first processing unit that executes a boot program stored in a storage unit that stores information to detect whether data constituting a control program stored in a first storage medium is broken, and, when the data constituting the control program is broken, transmits a signal indicating that the data is broken to the network; and
a second storage device connected to the network and including a second processing unit that determines, upon receipt of the signal from the first storage device, whether the first storage device is of same type as the second storage device based on identification information that identifies the first storage device, and, when the first storage device is of same type, transmits a control program stored in the second storage medium to the first storage device, wherein
the first storage device stores the control program transmitted from the second storage device.

5. The storage system according to claim 4, wherein the boot program is stored in an unrewritable area.

6. The storage system according to claim 4, wherein, upon receipt of the control program from the second storage device, the first storage device stores the control program received from the second storage device.

7. A storage device connected to a network of a plurality of storage devices that store a control program for controlling a processing unit that processes information, the storage device comprising:
a processing unit that executes a boot program for booting the storage device to detect whether data constituting a control program for controlling the storage device is broken, and, when the data constituting the control program is broken, obtains a control program from a storage device of same type as the storage device from the storage devices constituting the network, and writes the control program obtained from the storage device of same type to a storage medium.

8. The storage device according to claim 7, wherein the boot program is stored in an unrewritable area of the storage device.
